(19) United States
(12) Patent Application Publication
(10) Pub. No.: US 2007/0286296 A1
(43) Pub. Date: Dec. 13, 2007

(54) Method for Serially Transmitting Data Between a Transmitter and a Receiver

(75) Inventors: Philippe Chesne, Vendome (FR); Christophe Izard, La Ville Aux Clercs (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly sur Seine (FR)

(21) Appl. No.: 11/547,775

(22) PCT Filed: Apr. 4, 2005
(86) PCT No.: PCT/EP05/51505

§ 371 Date: Oct. 6, 2006

(30) Foreign Application Priority Data
Apr. 9, 2004 (FR) 0403768

(51) Int. Cl. H04L 7/033

(52) U.S. Cl. 375/259; 375/E07.003

(57) ABSTRACT

The invention pertains to a method of serially transmitting data between a transmitter and a receiver, the data being expressed by means of predefined words wherein consecutive bits, each bit being in a determined logic state out of two possible logic states. Changes of logic state between two bits transmitted by the transmitter occur only according to a first substantially regular period. The receiver reads the bits received from the transmitter only according to a second substantially regular period. The first and the second period are substantially equal. Each word transmitted comprises a first number of identical consecutive bits in the first logic state, the first number being at least equal to two, followed by at least two identical consecutive bits in the second logic state. Between two distinct words, the number of identical consecutive bits in the first logic state of each differs by at least three.

### BACKGROUND OF THE INVENTION

The invention pertains to a method of serially transmitting data between a transmitter and a receiver. The invention finds particular utility on a link effected between two onboard electronic devices in aeronautics.

In a known manner, a serial link is effected by means of an electrical conductor connecting a transmitter and a receiver. The transmitter sends over the link a word for example coded on eight bits. The word comprises seven data bits followed by a parity bit allowing the receiver to verify the integrity of the word. The receiver must be permanently synchronized with the words dispatched by the transmitter. This synchronization is for example obtained by means of electronic components of the receiver that are devised in such a way as to be permanently sensitive to any change of logic state on the link. Use is made for example of a flip-flop whose input is connected to the link and whose output makes it possible to load a register. The loading must be done at the frequency imposed on the serial link by the transmitter. The register has the size of a word transmitted over the link in this instance eight bits. When the register is full it sends an item of information to a processor so that the latter processes the word received by the receiver. This type of effecting of a serial link requires synchronization of the transmitter and of the receiver, components specific to the link as well as particular programming of the processor.

In onboard systems, especially in aeronautics, one seeks to reduce the size of the various elements forming the system. When it is necessary for various elements to be made to interconverse by dialog, it is sometimes important not to overburden these elements with components necessary to the link. One may also be constrained by an already significant processor loading rate, and the particular programming of the processor for operating the link may cause the maximum allowable loading rate to be exceeded.

### SUMMARY OF THE INVENTION

The invention aims to alleviate the problems cited above by proposing a method of serially transmitting data limiting the components and the programming necessary.

Accordingly, the subject of the invention is a method of serially transmitting data between a transmitter and a receiver, the data being expressed by means of predefined words comprising consecutive bits, each bit being in a determined logic state out of two possible logic states, characterized in that changes of logic state between two bits transmitted by the transmitter occur only according to a first substantially regular period, in that the receiver reads the bits received from the transmitter only according to a second substantially regular period, in that the first and the second period are substantially equal, in that each word transmitted comprises a first number of identical consecutive bits in the first logic state, the first number being at least equal to two, followed by at least two identical consecutive bits in the second logic state, in that between two distinct words, the number of identical consecutive bits in the first logic state of each differs by at least three.

### BRIEF DESCRIPTION OF THE DRAWING

The invention will be better understood and other advantages will become apparent on reading the detailed description of an embodiment given by way of example, description illustrated by the appended drawing in which:

FIG. 1 represents a link between a transmitter and a receiver;

FIG. 2 represents in time chart form the periodicity of the possible changes of state on transmission and the periodicity at which reception is carried out;

FIG. 3 represents three distinct words;

FIG. 4 illustrates the possible interpretation made by the receiver;

FIGS. 5, 6a, 6b and 6c illustrate a use of a method in accordance with the invention in the dialog between two instruments.

### DETAILED DESCRIPTION OF THE PREFERRED EMBODIMENT

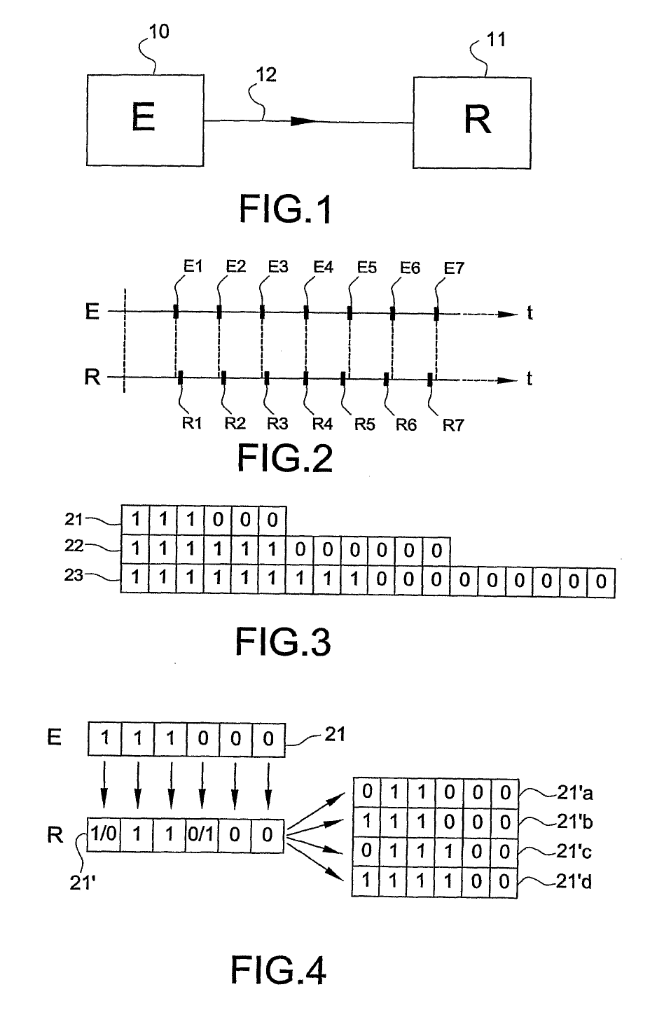

FIG. 1 represents a transmitter 10 and a receiver 11 between which a link 12 allows the transmission of data between the transmitter 10 and the receiver 11. The link 12 comprises for example just a single electrical wire. The data are expressed in words comprising bits. Each bit is in a determined logic state out of two possible logic states denoted 0 and 1. When the link 12 is electrical, the logic 0 state corresponds for example to an electrical voltage present on the link 12 of close to 0 V and the logic 1 state corresponds for its part for example to a voltage of close to 5 V.

FIG. 2 represents in time chart form on a first time line denoted E, instants E1 to E7 at which a change of state is apt to occur on the link 12. The changes of state are effected by the transmitter 10. The periodicity of these changes of state is substantially regular. FIG. 2 also represents in time chart form on a second time link denoted R, instants R1 to R7 at which the receiver 11 can read the logic state present on the link 12. The periodicity of the instants Ri is substantially regular and substantially equal to that of the changes of state, i representing an integer which in FIG. 2 lies between 1 and 7. To simplify the embodiment of the device, the receiver 11 reads the logic state only at instants Ri. The transmitter 10 and the receiver 11 each comprise for example a processor performing tasks cyclically. The processor of the transmitter 10 effects the changes of state at the start of its cycle. Likewise, the processor of the receiver 11 effects the reading operation at the start of its cycle. To implement the invention, it is not necessary to synchronize the processors of the transmitter 10 and of the receiver 11. Such synchronization would require an additional link between the transmitter 10 and the receiver 11. The invention makes it possible to dispense with this additional link. To implement the invention it suffices that the periodicity of the changes of state occurring at the instants Ei to be substantially equal to that of the instants Ri. FIG. 2 illustrates a slight desynchronization between the transmitter 10 and the receiver 11. The instants R1, R2 and R3 are slightly subsequent to the instants E1 to E3 respectively. The instants E4 and R4 are simultaneous and the instants R5 to R7 are slightly prior to the instants E5 to E7 respectively. Such desynchronization nevertheless makes it possible to implement a method in accordance with the invention.

A language between the transmitter 10 and the receiver 11 uses several words, three examples 21, 22 and 23 of which are given in FIG. 3. The first logic state is denoted 1 and the second logic state is denoted 0. In the difference of periodicity between the instants Ei and the instants Ri, it is possible to admit a shift that may be as much as a gap period over the duration of the longest word used in the language such as for example the word 23 if the language comprises only three words.

An essential characteristic lies in the differentiation of the words of the language. Each word transmitted comprises a first number of identical consecutive bits in the first logic 1 state, the first number being at least equal to two, followed by at least two identical consecutive bits in the second logic 0 state. Between two distinct words, the number of identical consecutive bits in the first logic 1 state of each differs by at least three. The word 21 comprises three identical consecutive bits in the logic 1 state followed by three identical consecutive bits in the 0 logic state. The word 22 comprises six identical consecutive bits in the logic 1 state followed by six identical consecutive bits in the logic 0 state. The word 22 comprises nine identical consecutive bits in the logic 1 state followed by nine identical consecutive bits in the logic 0 state. The word 21 forms the shortest word in the language. To ensure the recognition of the word 21 by the receiver 11, it suffices for it to comprise two identical consecutive bits in the logic 1 state followed by two identical consecutive bits in the logic 0 state. Nevertheless, the reliability of recognition of the word 21 by the receiver 11 is improved when the word comprising the smallest number of bits, in this instance the word 21, comprises three identical consecutive bits in the logic 1 state. Each of the following words, ordered by ascending bit number, comprises a number of consecutive bits in the logic 1 state which is equal to the number of consecutive bits in the logic 1 state of the preceding word plus three. Again to improve the reliability of recognition of the words by the receiver 11, for a given word, the number of consecutive bits in the logic 0 state is equal to the number of consecutive bits in the logic 1 state.

This makes it possible in particular to dispense with any parity bit generally sent at the end of a word and allowing the receiver 11 to check that a word is received correctly.

The method of recognition of the words by the receiver 11 may run in the following fashion: when the receiver receives a word, it identifies it as being a predefined word if the number of bits received consecutively in the logic 1 state is equal to the number of bits transmitted consecutively in the logic 1 state plus or minus a bit, and if the number of bits received consecutively in the logic 0 state is equal to the number of bit transmitted consecutively in the logic 0 state plus or minus a bit. The method of recognition of the words is illustrated with the aid of FIG. 4. The transmitter 10 sends over the link 12 the word 21 already described with the aid of FIG. 3. The word 21 is preceded by at least one bit in the 0 state. This bit in the 0 state may be the last bit of the preceding word transmitted by the transmitter 10. The word 21 received by the receiver 11 may be different. It is then called: word 21′ which may take four possible values denoted 21′a:011000, 21′b:111000, 21′c:011100 and 21′d:111100. There are three bits transmitted in the logic 1 state followed by three bits transmitted in the logic 0 state. As regards the word 21′ received if the number of bits received consecutively in the logic 1 state is equal to 2, 3 or 4 and if, thereafter, the number of bits received consecutively in the logic 0 state is equal to 2, 3 or 4, that is to say one of the words 21′a, 21′b, 21′c or 21′d, the receiver 11 will interpret one of the four possible combinations as corresponding to the word 21. Likewise, it is easy to understand that if the word 22 is transmitted, the word 22′ received can comprise only a number of bits received in the logic 1 state that can be only 5, 6 or 7, thereby making it possible to differentiate in certain fashion the word 22′ from the word 21′ and to improve the security of the transmission, in the word 22′ the bits in the logic 1 state can be followed only by 5, 6 or 7 bits in the logic 0 state.

It was seen above that the word 21 is preceded by at least one bit in the 0 state. More generally, for each word of the language, the bit preceding the first bit in the first logic 1 state is a bit in the second logic 0 state. Thus, the receiver 11 begins to count the bits in the 1 state when it sees a rising edge, or more precisely when it detects a logic 0 state during a cycle and when it detects a logic 1 state at the next cycle. This makes it possible to dispense with any bit announcing the start of a word, well known in the literature in English by the name “Start bit”.

Disturbances may occur on the link 12. For example, a bit of a logic state may be substituted by a bit of the other logic state. To illustrate this example, the word 21 may be received in the following fashion: 101000. The second bit of the word 21 normally in the logic 1 state has been read by the receiver 11 as being in the logic 0 state. To alleviate this problem, in the method of transmission, it is defined that, when the receiver 11 does not identify a word received as being a predefined word, the receiver 11 declares the word received invalid and waits for the next word.

If the disturbances persist, there is provision for, when the receiver 11 declares three successive words received invalid, the receiver 11 to then declare the link 12 invalid. In practice, an environment of the transmitter 10, of the receiver 11 and of the link 12 that is relatively disturbed leading to a desynchronization of 10% of the words transmitted has been simulated. With such an environment, the reliability calculation gives a probability of link declared invalid every 10¹⁴ hours, this representing excellent reliability.

Advantageously, in the transmission of data between the transmitter 10 and the receiver 11, the most frequently used words are chosen from among the words comprising the smallest number of bits. The mean transmission speed over the link is thus improved.

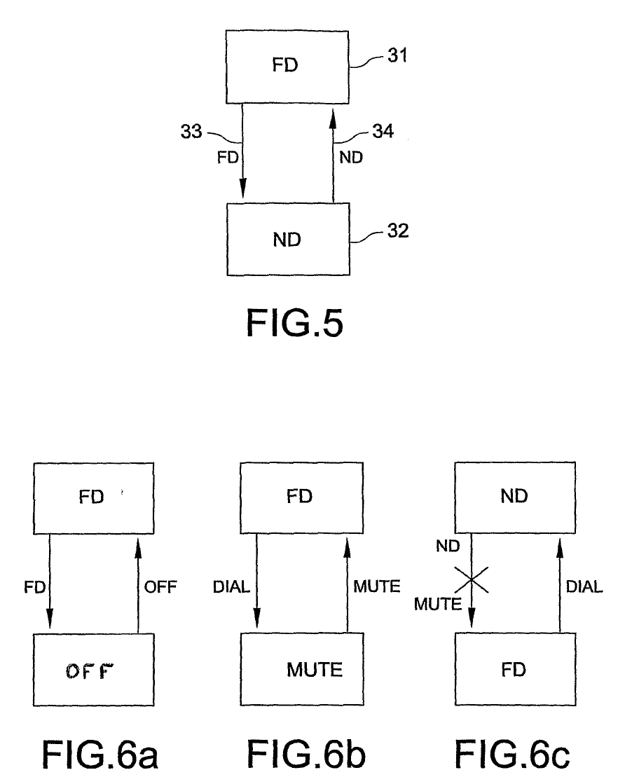

Illustrated by FIGS. 5, 6a, 6b and 6c, an exemplary implementation of a method in accordance with the invention is given in the aeronautical field. In new-generation wide-bodied aircraft, there is provision to install in the cockpit two combined backup instruments 31 and 32, subsequently called ICS, so as to improve the safety of piloting. An ICS makes it possible to autonomously measure the altitude, the speed, and the attitude of the aircraft. The ICS is used in case of a fault with the ordinary instruments made available to the pilot of the aircraft. The ICS also allows variable display. Each ICS 31 or 32 can display either a page dedicated to the flight parameters, page denoted FD, or a page dedicated to navigation, page denoted ND, or a page free of any display, denoted OFF. The pilot has the possibility of changing page on each of the ICSs by pressing a button. He can thus modify the display of each of the ICSs 31 and 32 as a loop from the FD page to the ND page then to the OFF page. Each ICS 31 and 32 comprises a transmitter function and a receiver function such as those described previously. The transmitter of the ICS 31 is linked to the receiver of the ICS 32 over a link 33 and the transmitter of the ICS 32 is linked to the receiver of the ICS 31 over a link 34. Each ICS 31 and 32 permanently transmits a word corresponding to the page that he is displaying. An FD word is transmitted when one of the ICSs 31 or 32 is displaying the FD page. The FD word has for example the same coding as the word 21 described with the aid of FIG. 3. An ND word is transmitted when one of the ICSs 31 or 32 is displaying the ND page. The ND word has for example the same coding as the word 22. An OFF word is transmitted when one of the ICSs 31 or 32 is displaying the OFF page. The OFF word has, for example, the same coding as the word 23. In the language between the ICSs 31 and 32, a word MUTE is added corresponding to a permanent logic 0 or 1 state signifying that the ICS transmitting this word is faulty or is not powered or else that the link over which the MUTE word is transmitted is cut. A word DIAL is transmitted when one of the ICSs 31 or 32 receives the word MUTE. The word DIAL comprises for example 12 bits in the logic 1 state followed by 12 bits in the logic 0 state to differentiate this word from the other words FD, ND and OFF. The display of the two ICSs is governed by two rules:

Never display the same page on both ICSs

Permanently display an FD page on one of the two ICSs.

These two rules are applicable regardless of the changes of display that are requested by the pilot on one of the ICSs. As required, the ICSs reconfigure their displays to comply with the two rules. In practice, if an ICS receives the FD word and if it displays an FD page, it reconfigures itself to display an ND page. This is illustrated by means of FIG. 5. If an ICS receives the word MUTE, ND or OFF it must verify that it is displaying an FD page, if not, it reconfigures itself to display an FD page. This is illustrated by means of FIGS. 6a, 6b and 6c. If an ICS receives the word DIAL, it must verify that it is not displaying an FD page, if not, it reconfigures itself to display an ND page. This is illustrated by means of FIGS. 6b and 6c.

Another advantage related to the invention is due to the fact that the words of the language between the transmitter 10 and the receiver 11 all have different lengths. In the case of a dialog between two items of equipment each comprising a transmitter function and a receiver function, as for example the two ICSs 31 and 32, when the receiver of a given ICS declares a word valid, it may be prompted to reconfigure itself and therefore to immediately interrupt the transmission of the word corresponding to the display that it had before reconfiguration, thus avoiding any effect of toing and froing in the dialog between the two items of equipment.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1-8. (canceled)

9. A method of serially transmitting data between a transmitter and a receiver, the data being expressed by means of predefined words comprising consecutive bits, each bit being in a determined logic state out of two possible logic states, wherein changes of logic state between two bits transmitted by the transmitter occur only according to a first substantially regular period, in that the receiver reads the bits received from the transmitter only according to a second substantially regular period, in that the first and the second period are substantially equal, in that each word transmitted comprises a first number of identical consecutive bits in the first logic state, the first number being at least equal to two, followed by at least two identical consecutive bits in the second logic state, in that between two distinct words, the number of identical consecutive bits in the first logic state of each differs by at least three.

10. The method as claimed in claim 9, wherein the bit preceding the first bit in the first logic state is a bit in the second logic state.

11. The method as claimed in claim 9, wherein the word comprising the smallest number of bits comprises three identical consecutive bits in the first logic state.

12. The method as claimed in claim 9, wherein for a given word, the number of consecutive bits in the second logic state is equal to the number of consecutive bits in the first logic state.

13. The method as claimed in claim 9, wherein in the transmission of data between the transmitter and the receiver, the most frequently used words are chosen from among the words comprising the smallest number of bits.

14. The method as claimed in claim 9, wherein when the receiver receives a word, it identifies it as being a predefined word if the number of bits received consecutively in the first logic state is equal to the number of bit transmitted consecutively in the first logic state plus or minus a bit, and if the number of bits received consecutively in the second logic state is equal to the number of bit transmitted consecutively in the second logic state plus or minus a bit.

15. The method as claimed in claim 9, wherein when the receiver does not identify a word received as being a predefined word, the receiver declares the word received invalid and waits for the next word.

16. The method as claimed in claim 15, wherein when the receiver declares three successive words received invalid, the receiver declares the link invalid.
